(19) United States
(12) Patent Application Publication
(10) Pub. No.: US 2025/0334490 A1
(43) Pub. Date: Oct. 30, 2025

(54) FLUID PROCESSING APPARATUS WITH AVERAGING MANIFOLD FOR PARAMETER MEASUREMENT

(71) Applicant: Munters Corporation, Amesbury, MA (US)

(72) Inventor: Amit Gitterman, Sandown, NH (US)

(21) Appl. No.: 18/644,350

(22) Filed: Apr. 24, 2024

(51) Int. Cl. G01N 1/26; B01D 53/06; B01D 53/26; B01D 53/30; F24F 11/89; F24F 110/20; G01N 1/22

(52) U.S. Cl. CPC G01N 1/26; B01D 53/06; B01D 53/261; B01D 53/30; F24F 11/89; G01N 1/2247; B01D 2257/80; B01D 2258/06; B01D 2259/4009; F24F 2110/20; F24F 2203/1032

(57) ABSTRACT

A fluid processing system for treating a fluid includes a passage through which a process fluid stream is directed and a sensing unit disposed at least partially in the process fluid stream for sensing a parameter relevant to the processing, such as humidity. The sensing unit includes a sensor to measure the parameter and a manifold in communication with the sensor. The manifold includes at least one trunk section and plural branch sections in fluid communication therewith, with each branch section having a branch inlet opening for receiving fluid from the process fluid stream, and each branch inlet opening being disposed at a different location across the process fluid stream. Fluid in the process fluid stream is directed into each of the branch inlet openings, through the branch sections, and into the trunk section where the fluid is presented to the sensing section of the sensor.

### CROSS-REFERENCE TO RELATED APPLICATIONS

None

### BACKGROUND OF THE INVENTION

### Field of the Invention

The present invention relates generally to heating, ventilating, and air conditioning (HVAC) systems and methods, and can be applied to air conditioning, dehumidification, or drying systems that incorporate a thermally activated desiccant wheel, among other systems. The present invention also provides improved and efficient measurement of a parameter, such as humidity, while using such systems.

### Description of the Related Art

Dehumidification is defined as a process of removing moisture from air, and several methods of dehumidifying air are known. Those commonly utilized involve refrigeration, desiccants, or both, as in a hybrid system. In the case of dehumidification using refrigeration, moisture from an airstream passed over a cooling coil condenses, thereby reducing the moisture in the air stream. In the case of dehumidification using desiccants, the process is one of absorption or adsorption. For absorption, either liquid or solid desiccants are used, typically halide salts or solutions. For adsorption, solid desiccants like silica gel, activated alumna, molecular sieve, etc., are used.

Some hybrid dehumidifier units are of the desiccant rotary type, a schematic view of which is shown in FIG. 12. In a typical rotary-type dehumidifier unit 10, the desiccant is contained in a rotary bed, also referred to as a desiccant rotor or desiccant wheel 12. Air to be dehumidified first passes through the evaporator coil 11 of a refrigeration system and then through the desiccant wheel 12. The desiccant wheel moves on a continuous or intermittent basis through, in its simplest form, two compartments or sectors, one for process 1 and the other for regeneration 2. The air to be dried is generally referred to as process air and the air used to regenerate the desiccant is referred to as regeneration or reactivation air. The terms regeneration and reactivation will be used interchangeably in this specification. In the process sector 1, the process air 14 driven by a process fan or blower 24, having passed through the evaporator coil 11 and a filter 13, then passes through the rotating wheel 12 and is dried by contact with the desiccant. In regeneration, air is brought in, generally from atmosphere, passed over a heat source 18 to elevate (raise) its temperature, and then passed as regeneration air 16 through the remaining portion of the wheel, that is, the reactivation or regeneration sector 2, by means of a regeneration fan or blower 26. This heats the wheel 12 and drives out the water content, thus enabling the wheel to adsorb more moisture in the reactivated portion of the wheel.

Control on many industrial dehumidification units is performed by a programmable logic controller (PLC) 60 using cascade control of proportional-integral-derivative (PID) loops, that is, control loops employing feedback widely used in industrial control systems requiring continuously modulated control. See FIG. 13. A singular humidity point sensor 15, such as a dew point/frost point sensor, is often used to measure the humidity level of the process flow downstream of the rotor. The sensor is positioned based on the unit configuration to best represent the temperature profile formation on the respective unit in which it is installed.

The control in the PLC involves the use of control loops, such as PID control loops, and continuously calculates an error value as the difference between a desired humidity setpoint SP and the measured humidity, for example, the measured dew point or frost point. The PLC 60 can employ one or more processing sections and one or more control loops. As the humidity level, that is, the dew point or frost point, of the process fluid is measured, the measured value is input to the PLC 60. If the measured value differs beyond the set point by a predetermined margin, then the PLC 60 controls the other components of this system to bring the measured value back toward the set point. For example, the PLC 60 can control one or more of the heater 18, the blower motors 24, 26, the wheel motor 28 to drive the rotor 12, and the refrigeration system to control the evaporator coil 11.

Humidity measurements in industrial dehumidifiers commonly use dew/frost point temperature measurements for low humidity applications. Frost point temperature can be simplified as a dew point temperature at which a gas must be cooled for the water vapor to condense into frost. In applications where very low temperatures and very dry air are required, frost point measurements are preferred. For example, the DRYCAP® Dew Point Transmitter DMT152 manufactured by Vaisala is designed for measuring dew points as low as −80° C. These sensors do not need expensive calibrations and have an internal built-in purge cycle. They can be twenty times faster than aluminum oxide sensors and can be mounted externally to a duct, with the sensor tip extending into the interior of the duct to be exposed to the airstream. Such sensors are not flow-dependent and can measure still air just as well as moving air. Nevertheless, at least a small flow rate ensures the air to be measured reaches the sensor.

One concern in measuring parameters, such as humidity, in target fluid streams, such as the process air stream from the wheel 12, is stratification, in which layers of process air downstream of the wheel 12 have significantly different levels of humidity. That is, the process outlet from the rotor supplies highly stratified air to the dehumidifier unit outlet. Because the process air immediately downstream of the rotor is highly stratified, placing a sensor at this location will output results dependent on the mixing levels of the air. While mixing devices can attenuate dew point reading errors, they cannot be eliminated due to uneven velocity profiles that may form due to the mixing, particularly in ductwork of large cross-section. Air flow in the ductwork can range in velocity from 700 fpm to 1500 fpm, for example, depending on the duct branch. The average velocity in a fully developed profile is spatially and temporally dependent. Moreover, ducts in certain systems undergo transitions that further cause alterations in velocity profiles. Changes in flow direction caused by duct bends and plenum fittings such as branch takeoffs can create significant air profile alterations. While such a varied velocity profile can be overcome by undulated duct design and long runs of ductwork, such may not be practical in certain applications, such as where the footprint of the system must be kept to a minimum.

After a humidification system is installed at a location, recognizing that humidification stratification may exist, the system can be calibrated to operate at desired set dew points. Such calibration can include measurements usually conducted by testing and balancing with calibration sensors. For example, the Handheld Dewpoint Meter DM70 or Indigo80 Handheld Indicator by Vaisala can be used for spot checking in field calibration and can be used on a traverse layout accessed through the lateral surface of the ductwork connecting the dehumidifier process outlet to the process area, such as a dry room. In traverse calibration, the probe of the handheld unit can be sequentially positioned at a grid of points within a planar cross-section of the ductwork to determine the dew point at each point in the grid. The various measurements in the grid can then be averaged to determine the average dew point for calibration. Such measurements cannot be made during normal use of the dehumidifier as a practical matter, and even if the system is accurately calibrated upon installation, conditions can change over time. For example, as the system ages, the velocity profile may change due to changes in performance over time of any of the components, such as deterioration of air passing through the rotor due to clogging of the internal passages within the rotor. Any changes to the ductwork can affect velocity profiles both upstream and downstream of the modification. Daily and seasonal environmental changes, such as in temperature, humidity, and atmospheric pressure, can affect fluid flow. Such changes may result in inaccurate dew point readings from the single point sensor.

One specific application of industrial dehumidifier units is in the manufacture of batteries, such as lithium-ion batteries, which are commonly used in electric vehicles (EVs). Lithium-ion batteries require controlled temperature and humidity. If a lithium-ion battery is exposed to moisture during production, such may lead to impaired quality that may affect product life and charging capacity, and can further give rise to serious safety concerns. As a result, lithium-ion battery manufacturing requires very strict environmental conditions with constant real-time monitoring. For example, materials composing such batteries are highly hygroscopic, necessitating continuous regulation of humidity levels within a narrow range. Throughout manufacturing and assembly, for example, dry rooms for manufacturing and assembly of lithium-ion batteries can require extremely low dew or frost points, reaching down to −80° C. The hybrid dehumidifier system is particularly effective and efficient in reaching such target dew and frost points on a reliably consistent basis. Under these frost point conditions, however, moisture stratification can intensify and the need for air moisture content averaging along a cross-sectional profile is needed.

Improvements in dehumidification effectiveness, efficiency, and precision are desired. Improved humidity measurement is important in achieving these goals.

### SUMMARY OF THE INVENTION

This invention is intended to account for moisture stratification in fluid streams, such as at the process outlet side of a rotor, including those used in dehumidifiers. Such will improve precision in humidity measurement, thereby improving dehumidification effectiveness and efficiency as well as safety.

According to one aspect of the present invention, a fluid processing system for treating a fluid includes a passage through which a process fluid stream is directed in a process flow direction, the process fluid stream containing fluid to be processed; and a sensing unit disposed at least partially in the process fluid stream for sensing a parameter relevant to the processing, the sensing unit comprising a sensor having a sensing section for contact with the fluid from the process fluid stream to measure the parameter in the process fluid stream; and a manifold in communication with the sensing section of the sensor, the manifold comprised of at least one trunk section and plural branch sections in fluid communication with the at least one trunk section, each of the branch sections having a branch inlet opening for receiving fluid from the process fluid stream, each of the branch inlet openings being disposed at a different location across the process fluid stream, wherein fluid in the process fluid stream is directed into each of the branch inlet openings, through the branch sections, into the trunk section where the fluid is presented to the sensing section of the sensor, and then back into the process fluid stream.

According to another aspect of the present invention, a fluid processing system for treating a fluid includes a rotor having at least a process segment through which a process fluid stream is directed in a process flow direction and a regeneration segment through which a regeneration fluid stream is directed in a regeneration flow direction; a blowing device disposed on one side of the rotor for causing movement of a target fluid stream through a passage; and a sensing unit disposed at least partially in the target fluid stream on one side of the rotor for sensing a parameter. The sensing unit includes a sensor having a sensing section for contact with the fluid from the target fluid stream to measure the parameter in the target fluid stream, and a manifold in communication with the sensing section of the sensor, the manifold comprised of at least one trunk section and plural branch sections in fluid communication with the at least one trunk section, each of the branch sections having a branch inlet opening for receiving fluid from the target fluid stream, and each of the branch inlet openings being disposed at a different location across the target fluid stream. Fluid in the target fluid stream is directed into each of the branch inlet openings, through the branch sections, into the trunk section where the fluid is presented to the sensing section of the sensor, and then back into the target fluid stream.

According to yet another aspect of the present invention, a control method can control a fluid processing system for treating a fluid, the system comprising a passage through which a process fluid stream is directed in a process flow direction, the process fluid stream containing fluid to be processed, and a sensing unit disposed at least partially in the process fluid stream for sensing a parameter relevant to the processing, the sensing unit including a sensor having a sensing section for contact with the fluid from the process fluid stream to measure the parameter in the process fluid stream, and a manifold in communication with the sensing section of the sensor, the manifold comprised of at least one trunk section and plural branch sections in fluid communication with the at least one trunk section, each of the branch sections having a branch inlet opening for receiving fluid from the process fluid stream, and each of the branch inlet openings being disposed at a different location across the process fluid stream. The method includes directing fluid in the process fluid stream into each of the branch inlet openings, through the branch sections, into the trunk section where the fluid is presented to the sensing section of the sensor, and then back into the process fluid stream, determining a weighted average of the parameter of the fluid in the process fluid stream from the fluid presented to the sensing section of the sensor, and controlling the fluid processing system based on the determined weighted average of the parameter.

A better understanding of these and other aspects of the present invention may be had by reference to the drawings and to the accompanying description, in which preferred embodiments of the invention are illustrated and described.

### BRIEF DESCRIPTION OF THE DRAWINGS

FIG. 1 is a perspective view of an embodiment of a dehumidifier unit according to the present invention.

FIG. 2 is cross-sectional view of the region proximate the desiccant wheel in the embodiment of the dehumidifier unit according to the present invention.

FIG. 3 is a schematic diagram of a rotor dehumidification system of the dehumidifier unit according to the present invention.

FIG. 4 is a perspective view of a front side of the sampling manifold used in a dehumidifier unit according to the present invention.

FIG. 5 is an exploded perspective view of the front side of the sampling manifold.

FIG. 6 is an exploded perspective view of the rear side of the sampling manifold.

FIG. 7 is an enlarged, exploded perspective view of the front side of the sampling manifold.

FIGS. 8 and 9 depict test results of dew/frost point measurement temperatures at the rotor outlet according to the present invention and comparative testing.

FIGS. 10 and 11 depict test results of dew/frost point measurement temperatures at the rotor outlet according to the present invention and comparative testing.

FIG. 12 is a schematic view of a known rotary-type dehumidifier system.

FIG. 13 is a schematic diagram of a known control system in a rotary-type dehumidifier system.

### DETAILED DESCRIPTION OF THE EMBODIMENTS

The present invention will now be described with reference to the accompanying drawings, which are illustrative of certain embodiments of the invention. Variations and modifications are possible without departing from the spirit and scope of the invention.

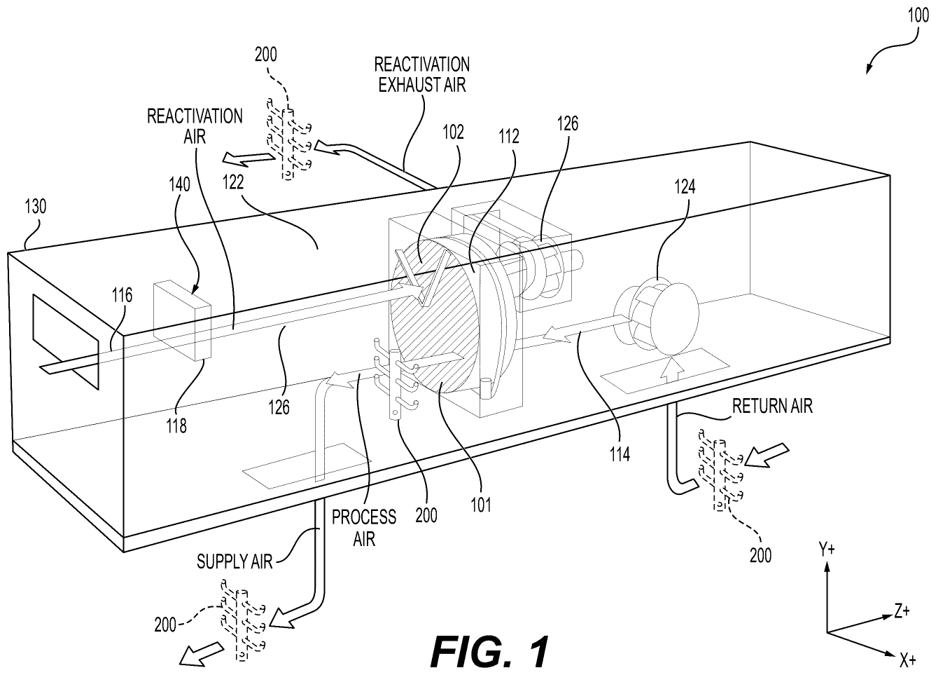

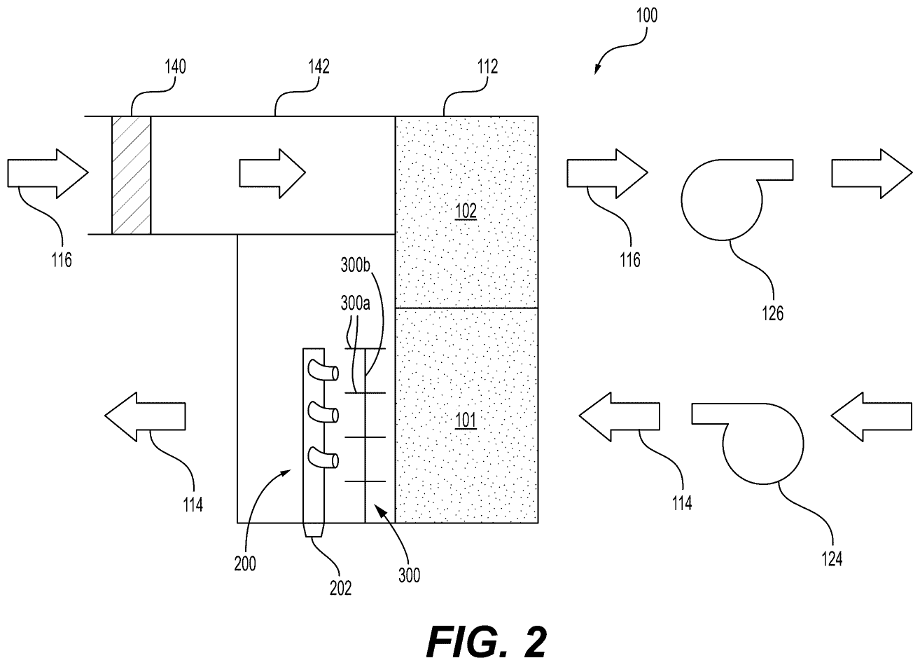

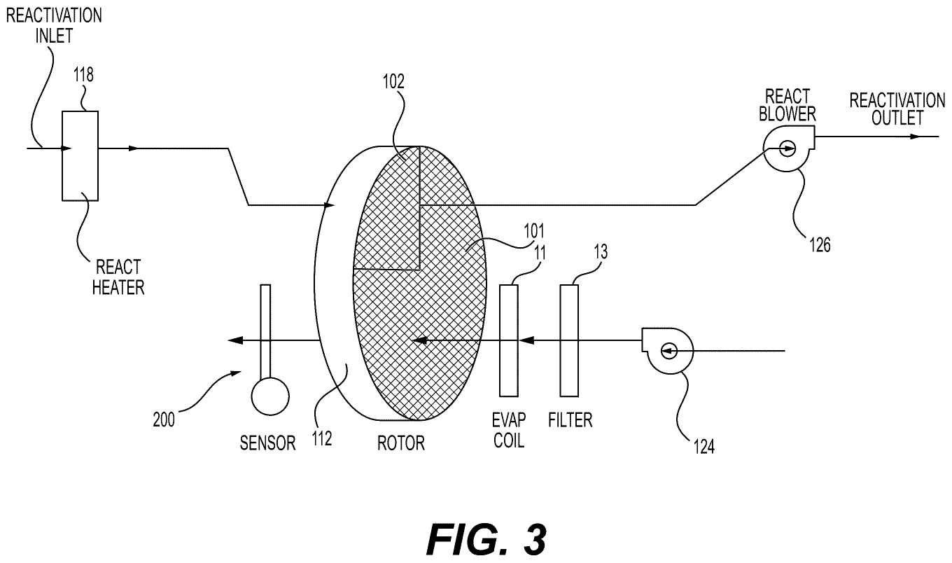

FIGS. 1-3 illustrate an embodiment of the present invention. In particular, FIG. 1 is a perspective view of an embodiment of a dehumidifier unit according to the present invention; FIG. 2 is cross-sectional view of the region proximate the desiccant wheel in the embodiment of the dehumidifier unit according to the present invention; and FIG. 3 is a schematic diagram of a rotor dehumidification system of the dehumidifier unit according to the present invention. In the figures, the direction of flow is designated as the +z (or −z) direction, the horizontal direction transverse to the direction of flow as the +x (or −x) direction, and the vertical direction as the +y (or −y) direction. In the following description, the reactivation air flows in the +z direction and the process air flows in the −z direction, but such is not intended to be limiting.

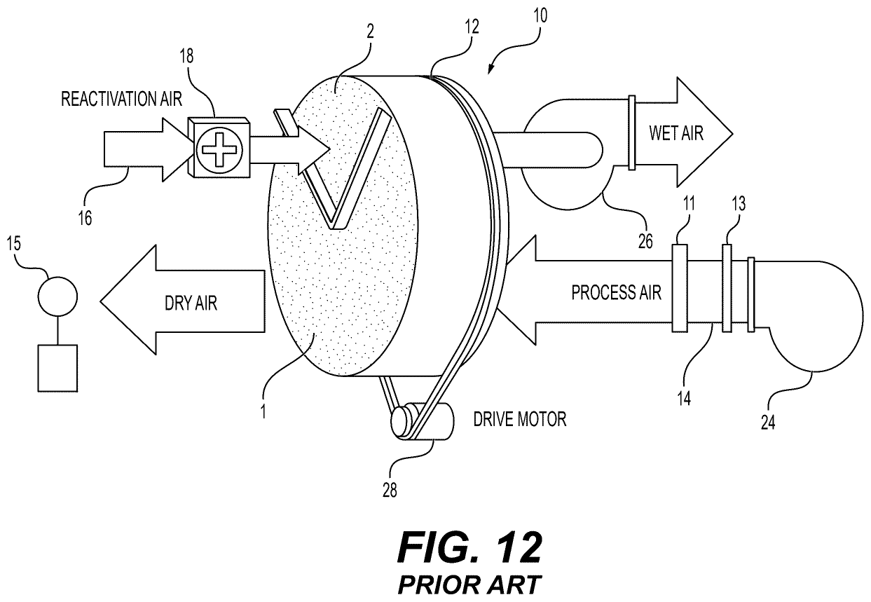

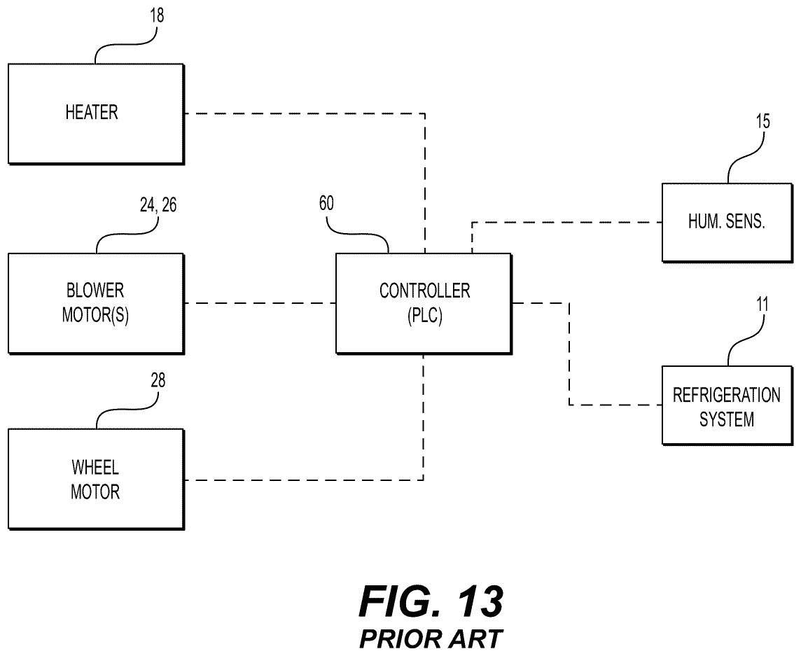

Referring first to FIG. 1, the main components and the overall operation of dehumidification unit 100 according to an embodiment of the present invention will be described. As with the prior art dehumidification unit 10 shown in FIG. 12, dehumidification unit 100 includes a desiccant rotor 112, a reactivation heater 118, a process blower or fan 124 for moving process air 114, and a reactivation blower or fan 126 for moving reactivation air 116. The various components of the dehumidifier unit 100 are preferably housed in housing 130. A sub-heater assembly 140 is disposed upstream of desiccant wheel 112 with respect to the direction of flow of the reactivation air (+z direction) and includes reactivation heater 118. The reactivation heater 118 can be any one of direct fire gas (DFG), indirect fire gas (IDFG), and electric heater types. Unshown ductwork is provided to guide the reactivation air from its source, such as outside air, to the desiccant wheel 112. Likewise, unshown ductwork is provided to guide the process air from the desiccant wheel downstream to a process area, such as to a dry room.

As with the desiccant dehumidifier unit 10 described with respect to FIG. 12, the wheel 112 moves on a continuous or intermittent basis through the two sectors, the process sector or zone 101 and the regeneration sector or zone 102. However, the present invention is not limited to this arrangement. Often, another sector is added between the process and regeneration sectors, and can be referred to as a purge sector. A third airstream (generally called the purge air) is passed through the purge sector and becomes a portion of the regeneration air. The incorporation of the purge sector helps to recover some residual heat from the rotating wheel 112 before it enters the process sector, thereby reducing the overall energy requirement for regeneration, as well as improving the overall moisture removed by the wheel 112. Other sectors, such as isolation sectors can be utilized. The invention of this disclosure is particularly suitable in known systems such as PowerPurge® and Green PowerPurge® systems by Munters Corporation, as well as Munters' 5-Zone Desiccant rotor systems.

As with the desiccant dehumidifier unit 10 described with respect to FIG. 12, the dehumidification system of the embodiment uses a humidity sensor to measure humidity levels in the process airstream downstream of the process section of the rotor. Even though the inventor recognizes that an air velocity profile and humidity stratification may occur where the humidity sensor is placed, a single sensor can be used. As shown in FIG. 1, humidity sensor unit 200 is positioned just downstream of the process sector of rotor 112. However, this is not to be limiting. Humidity sensor unit 200 can be placed just downstream of the rotor or anywhere between the rotor and the space to be dehumidified (dry room), including at the inlet to the space to be dehumidified. That is, the humidity sensor unit 200 can be placed within the casing of the dehumidifier unit or in any passages, like ductwork, connected thereto, essentially anywhere the process fluid flows, particularly at any location where stratification may occur. Further, although a single humidity sensor unit 200 is described in the embodiment, more than one sensor unit can be positioned along the process airstream or any target airstream. For example, one humidity sensor unit 200 can be placed just downstream of the rotor as shown in solid lines in FIG. 1, and one or more other humidity sensor units 200 can be placed downstream thereof or in other target airstreams, as shown in dashed lines in FIG. 1.

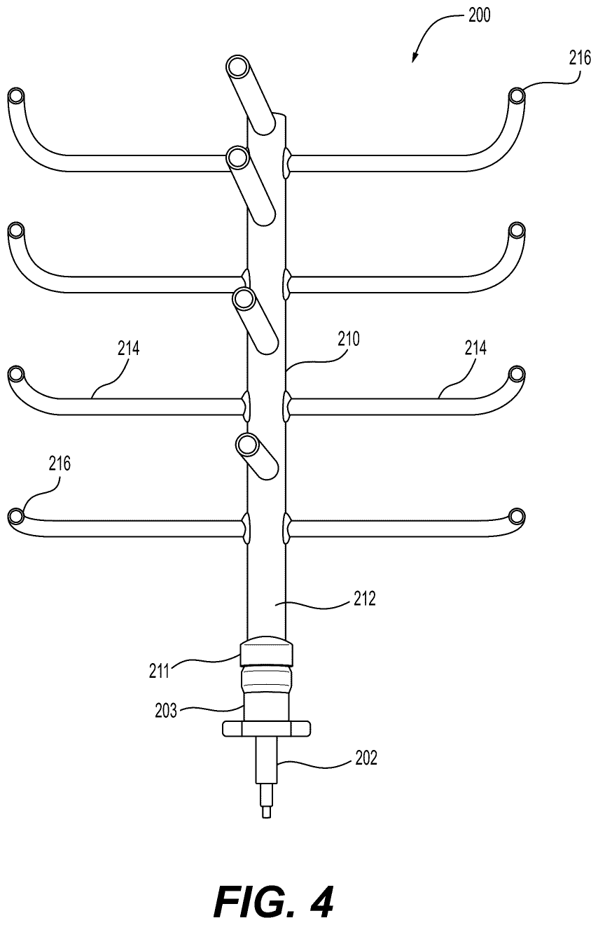

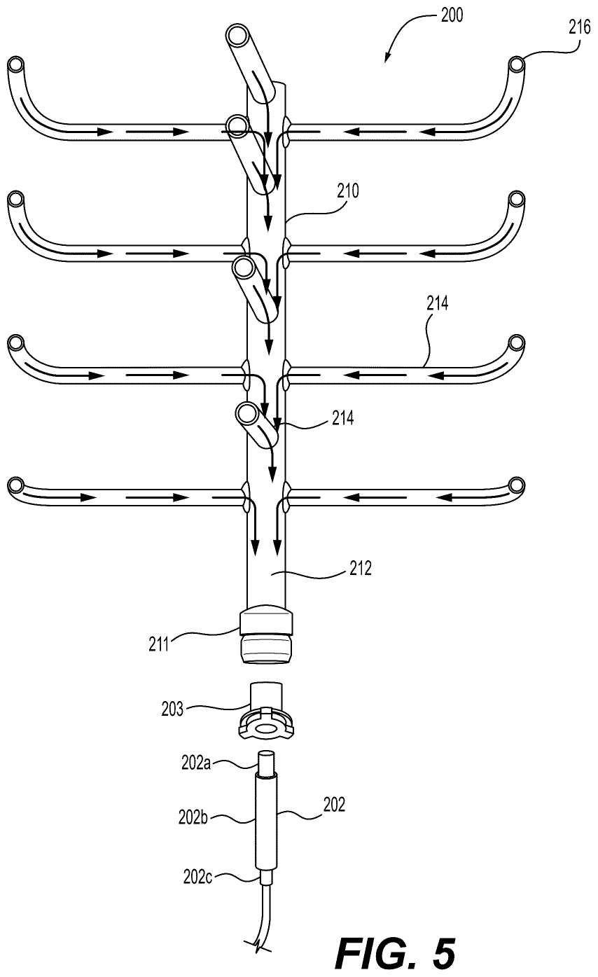

Referring to FIGS. 4-7, humidity sensor unit 200 includes a sensor module 202, a sensor adapter 203, and a sensor manifold 210. Sensor adapter 203 is used to secure sensor unit 200 to ductwork, plenum, or other passage through which the process airstream flows, as well as to connect sensor module 202 to sensor manifold 210. Sensor manifold 210 functions as a mechanical averaging device to present air flow samples from an airstream having any velocity profile to sensor module 202. That is, sensor manifold 210 acts as an averaging manifold. Sensor module 202 can be any known humidity sensor module, but preferably measures humidity by determining the dew point or frost point temperature of the airstream. For example, capacitive thin film polymer sensors can be used. The DRYCAP® Dew Point Transmitter DMT152 manufactured by Vaisala is one example. It should be noted that while in the disclosed embodiment humidity is measured, the invention is not to be limited to this particular parameter. Any parameter that may vary throughout the profile of an airstream may be suitable for such measurement, as long as the appropriate sensor module is used.

Sensor manifold 210 includes a mounting flange 211, a main trunk 212, and plural arms 214. Each arm 214 is fluidly connected to trunk 212 and includes an opening 216 at its distal end. The arms are arranged such that openings 216 face the process air flow traveling in the −z direction. In the shown embodiment, twelve arms 214 are shown, but the invention is not limited to this particular number. More or fewer arms 214 can be used depending on the desired accuracy of measurement. The arms are arranged such that openings 216 can form a grid along a plane perpendicular to the process air flow, for example in the x-y plane. Preferably, openings 216 are all located substantially in the same plane and in a symmetrical manner. In the shown embodiment, four openings 216 are provided at both the left and right sides of trunk 212 and four are provided in line with the trunk. This arrangement effectively establishes a mesh of openings along a cross-section of the process air flow, so as to gather sample process air from different locations along the velocity profile. The more openings 216 provided in the manifold 212, the more sample readings can be taken to more accurately reflect the average humidity in a stratified flow. The cross-sectional area of each of openings 216 should be less than the cross-sectional area of trunk 212. It is further preferred that the sum of the cross-sectional areas of each of openings 216 should be no greater than the cross-sectional area of trunk 212. In a preferred embodiment, but not shown in the drawings, the rims of openings 216 are flared relative to the diameter of arms 214, that is, in a funnel-like shape, so as to effectively capture the sample airflow, but such is not limiting.

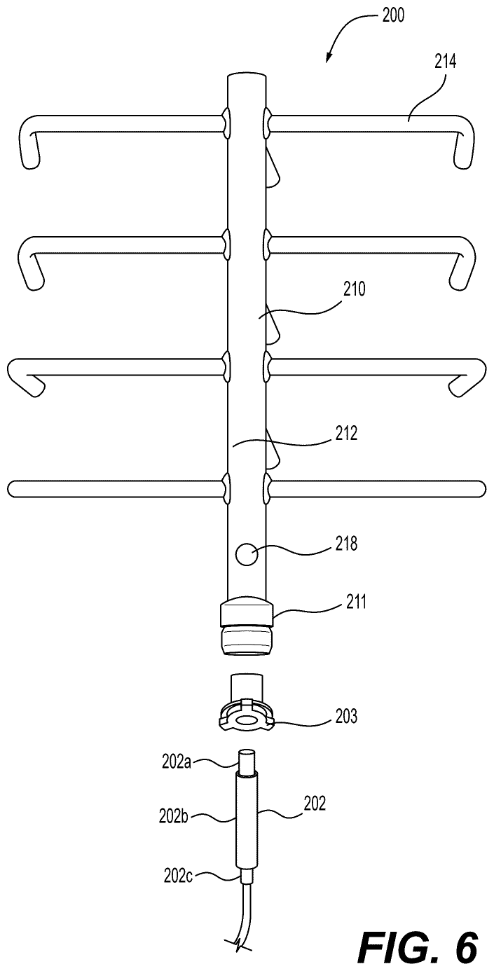

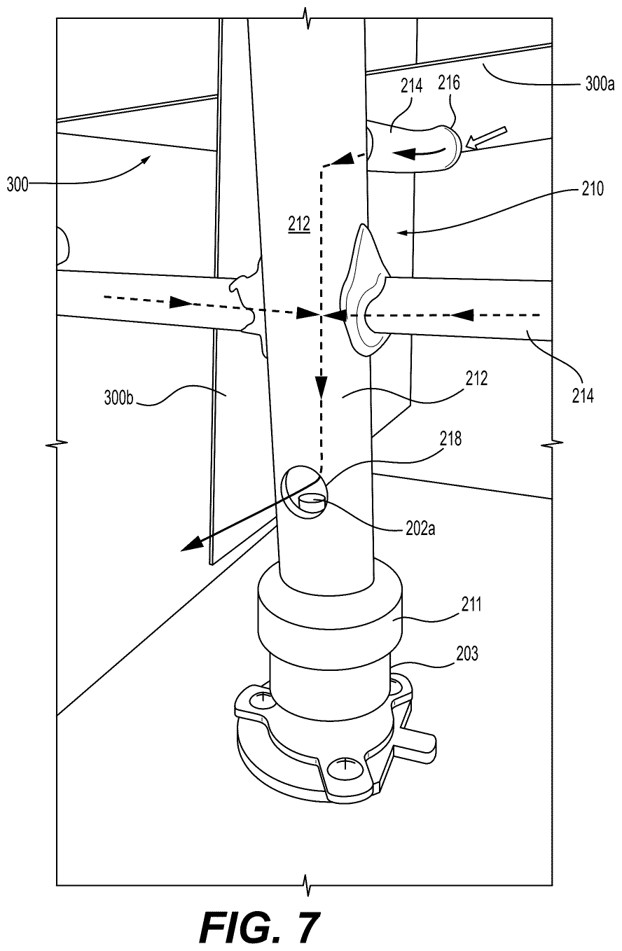

As shown in FIGS. 6 and 7, manifold 210 further includes and outlet port 218 disposed on its rear side relative to the process fluid flow. Outlet port 218 is of a cross-sectional area less than that of trunk 212 so as to create increased air flow therethrough. Sensor module 202 includes a sensor tip 202a, a sensor body 202b, and a sensor base 202c. When mounted within trunk 212, sensor tip 202a is preferably positioned adjacent outlet port 218. In this manner, air from the process fluid stream passes into openings 216, through arms 216 and trunk 212, and then past sensor tip 202a and out outlet 218 back into the process airstream. The sampled fluid never leaves the system, e.g., never leaves the ductwork, such that the sensing can be performed in situ. Thus, fluid samples from throughout the process fluid profile are collected, mixed in the trunk 212, and presented to sensor tip 202a in an averaging manner.

Manifold 210 can be formed of any suitable material, but is preferably made of a non-reactive metal, such as stainless steel. Arms 216 can be attached to trunk 212 in any known manner, such as by brazing, soldering, or welding, but such is not limiting. What is important is that the connections are airtight and the flow of air from opening 216 through the arms and into trunk 212 is smooth without restriction. Mounting flange 211 can be connected to trunk 212 in a similar manner. Mounting flange 211 is intended to be connected to adapter 203 by any known connection. For ease of installation, both the upper side of adapter 203 and flange 211 can have complementary threading so that they can be screwed together for a secure connection.

Flange 211 of manifold 210 is intended to receive sensor module 202 in its interior and to be secured to the process flow ductwork, for example, the lower wall of the ductwork. To that end, adapter 203 includes an adapter mounting flange 203a, and an adapter body 203b having a hollow interior to receive sensor module 203, and the threaded upper section for connection to flange 211 of manifold 210. Sensor module 202 can be secured to adapter 203 in any suitable manner, such as by complementary threading, friction fit, or adhesive, but it is important that there be no fluid leakage past sensor module 202 external of the ductwork. Adapter 203 and manifold 210 are designed such that when assembled, sensor tip 211a will be precisely positioned adjacent outlet 218. For example, in the shown embodiment, sensor tip 202a is positioned substantially at the halfway point of outlet 218 in the vertical (y) direction. See FIG. 7.

As noted above, it is important that there be no fluid leakage past sensor module 202 external of the ductwork. One reason the humidity measurements are done in their entirety inside the ductwork (or inside the air handling unit), that is, in situ measurements, is to prevent contamination (such as humidity incursion) of the process fluid, as well of leakage of the process fluid out of the system. No measurements are made with induced air pump or with air sampling. All air that is measured is drawn back into the environment from which it was sampled. This feature is important due to the counterflow diffusion phenomenon, that is, when moisture moves against the direction of flow due to pressure gradients. When there is a pressure difference between two regions, moisture can move from an area of higher pressure to an area of lower pressure. In counterflow diffusion, even if the overall flow direction is from one point to another (for example, from left to right), localized pressure differences can cause moisture to move against this flow, effectively traveling upstream. With the instant invention, localized pressure gradients are minimized (when compared to pressure gradients ex situ to the ductwork).

In installation, sensor module 202 is secured to adapter 203, which in turn is secured to the exterior wall of the process flow ductwork in any known manner, such as using screws or nuts and bolts. Again, it is important that no fluid leaks from the ductwork, so if screws and/or nuts and bolts are used, suitable sealing washers or other sealing means is necessary. After adapter 203 is secured to the ductwork, with the sensing tip 202a of sensor module protruding into the interior of the ductwork, the manifold 210 is attached to the adapter 203, with the exposed portion (including sensing tip 202a) of the sensor module 202 being positioned within main trunk 212. Then, the manifold is secured to the adapter, such as by a threaded connection. Alternatively, instead of securing the adapter to the underside of the ductwork, the threading between the manifold 210 and the adapter 203 can sandwich the wall of the ductwork therebetween to secure the connection.

It is important that outlet 218 be positioned as close to the wall of the ductwork as possible. In fluid dynamics, it is known that the velocity of a fluid flowing through a passage, such as ductwork, is slowest at the boundaries, that is, at the walls of the ductwork. Therefore, the dynamic pressure, which varies along with the velocity profile, is also lowest at the boundaries. By positioning outlet 218 as close to a wall of the ductwork as possible, the fluid pressure at the outlet will be closer to the static pressure of the fluid flow. In this arrangement, the openings 216 of the arms 214 of the manifold 210 will experience different dynamic pressures due to the velocity profile, but after passing through the arms 214 and the trunk 212, the air samples from the various openings 216 will be presented at the sensor tip 202a at close to static pressure. This arrangement thereby acts as a mechanical averaging manifold so that the sensor module 202 can constantly and instantaneously measure the average humidity in the process fluid flow. Using this averaging measurement, the average humidity level, that is, dew point or frost point temperature, can be input to the PLC in a continuous manner for more precise feedback, thereby allowing the humidity of the process air flow to be maintained within an acceptable range of the setpoint humidity.

It is known that many dry rooms utilize humidity sensors in the space to monitor humidity levels therein. Nevertheless, the humidity sensor of the present invention, which is preferably positioned downstream of the rotor and upstream of the inlet to the dry room, is still of importance when used in conjunction with the dry room humidity sensor. First, the humidity sensor of the present invention can be used in the control of the dehumidifier as an input to a feedback loop, while providing a more accurate measurement for input. Further, the humidity sensor of the present invention can be used as preventative primary alarm that can prevent elevated moisture diffusion into the dry room. For example, if elevated humidity levels are detected by sensor unit 200, then an alarm can issue and the process can be shut down before humidity levels in the dry room raise to dangerous levels. If a single sensor without an averaging manifold were to be used, such might not detect high humidity levels in strata other than the stratum where the sensor is disposed.

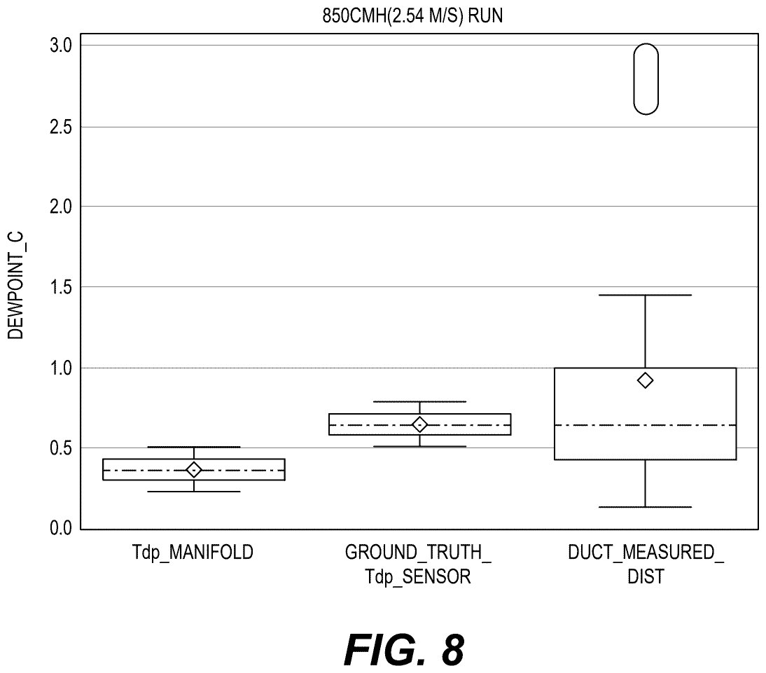

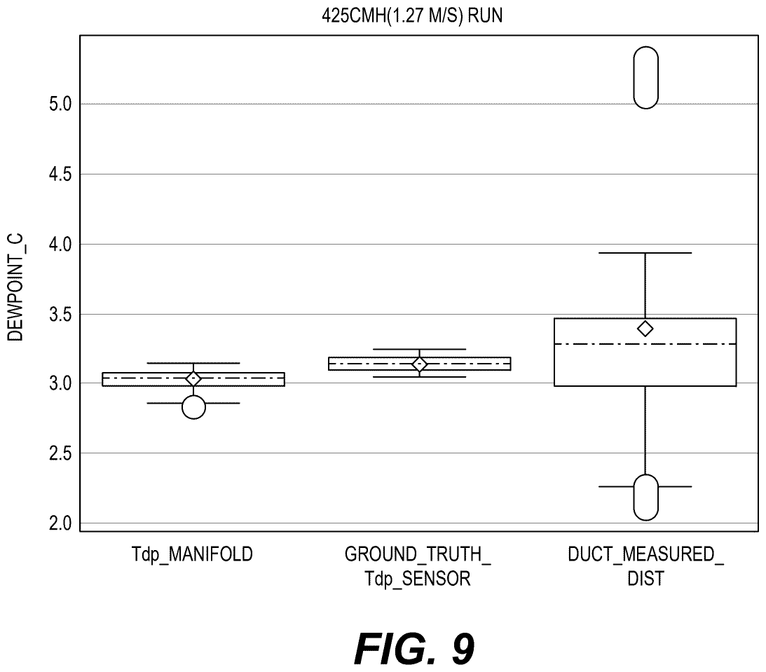

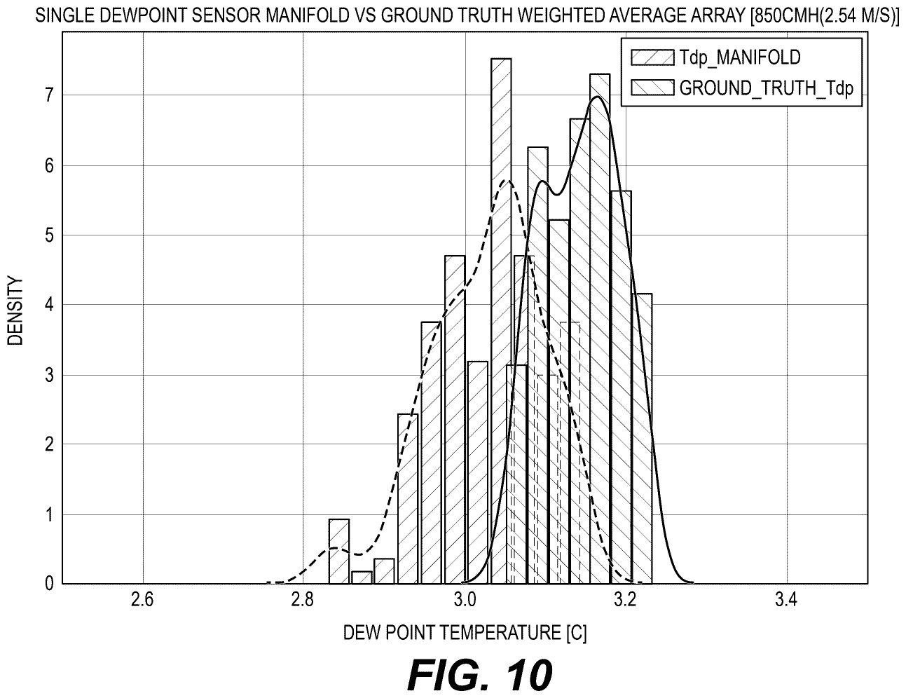

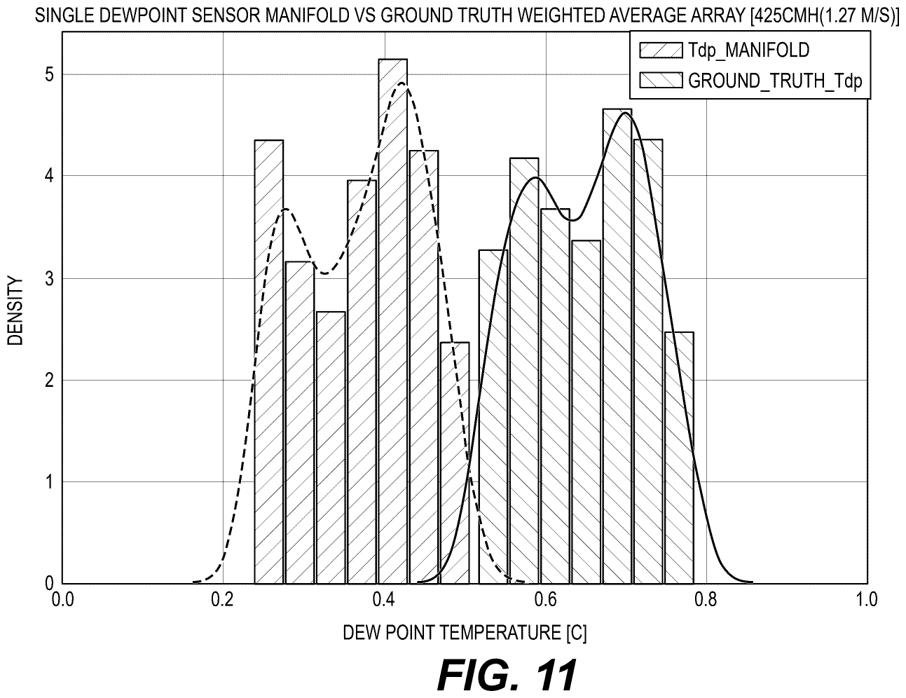

Comparative testing was performed between a sensing unit constructed and installed according to the described embodiment of the present invention and a testing model described below. As to the testing of the embodiment, a sensing unit 200 including manifold 210 and sensor module 202 was installed in model fluid ductwork downstream of rotor 112, two induced air profiles were generated at two different flow rates, 425 cubic meters per hour (CMH) and 850 CMH, and sampling results from the sensor module were recorded (Tdp_Manifold). In the model testing for comparison, nine sensors of the same model as sensor module 202 were positioned along the cross-section of interest at a similar distance and measured the same two induced air profiles. The results from the multiple sensors in the model testing (Duct_Measured_Dist) were averaged to determine a “ground truth dew point temperature” (Ground_Truth_Tdp Sensor). The results of the testing are shown in FIGS. 8 and 9. As can be seen in FIG. 8 with regard to the 850 CMH run, the range of measurements from the multiple sensors with regard to the model testing had a very wide range of results (Duct_Measured_Dist). These were averaged and weighted based on velocity and temperature to determine the ground truth temperature (Ground_Truth_Tdp Sensor). Comparing Tdp_Manifold to Ground_Truth_Tdp Sensor, both had a very narrow range of test results and the difference in average dew point was within an acceptable range. Results were even better in the 425 CMH run. That is, the range of test results was even narrower and the average Tdp_Manifold dew point was even closer to the ground truth dew point (Ground_Truth_Tdp Sensor). The results of the embodiment of the invention and the model testing were further analyzed as shown in the FIGS. 10 and 11, which are probability density function diagrams. These diagrams show that the sensor unit 200 of the present invention can provide an accurate reading when compared to the nine-sensor model.

Modifications can be made to the above-described embodiments. For example, testing was further performed by installing stream guides, such as vanes, upstream of sensor unit 200. Referring to FIGS. 2 and 7, flow guide 300 can be installed upstream of sensor unit 200. Flow guide 300 includes vanes 300a mounted on a support 300b. Vanes 300a are mounted so as to be substantially parallel to the process stream as shown in the figures. It is believed that the vanes 300a guide the process air so as to produce a more defined stratified air stream layer to be directed at the specific locations of the openings 216 of manifold 210. Such produced improved comparative test results to achieve higher sensor sensitivity.

In addition, pressure differential monitoring between the inlets 216 and outlet 218 of the manifold 212 can be implemented while providing a controlled orifice opening at the sensor section. The size of the orifice opening can be controlled based on the monitored pressure differential. A set point can be established to maintain a regulated sensor compartment airflow speed to maintain repeatable measurement rates. Further, while the invention is directed to in situ air sampling with no sampling pumps, another modification is to induce mechanical forced suction flow through the manifold outlet 218 under certain situations, such as during unit shutdown periods. This can maintain on-demand functionality of the dew point condition and be used to detect moisture infiltration prior to dehumidifier re-engagement (that is, starting the dehumidifier after a planned or unplanned shutdown). This will allow purging the unit during its transient state until dew point conditions are achieved prior to routing the unit process outlet to the dry room, thus resulting in a shorter time to functional manufacturing conditions.

With the present invention, dynamic pressure gradients can be used to sample moisture content in an airflow based on its prevalence (that is, the velocity vector magnitude), and average the sampled air to be read by a single dew point/frost point sensor, thus eliminating the need for and expense of multiple sensors to cover large cross-sections of interest. Force proportional averaging is achieved by mixing moisture content arriving at the sensor from high velocity layers and low velocity layers, thereby emphasizing the dew point measurement with spatial relevance. This can eliminate speculation regarding the best representative dew point sensor placement in a supply duct, and allow for measurements at partially-mixed regions, realizing that fully mixed regions are only an assumption under changing supply air conditions. The invention can provide a repeatable, continuous methodology to produce a reliable dew point/freeze point reading, and can allow for a preventative alarm methodology at the source, that is, at the dehumidifier level.

The foregoing embodiments have been described with respect to dehumidifier units, but are not intended to be limited thereto. For example, the sensor manifold 210 described herein may also be effective in mechanical averaging of fluid flow in other HVAC systems. Likewise, although this invention is intended to acquire more accurate readings of humidity at the process outlet side of a rotor, such as those used in large scale dehumidifiers, the described humidity sensing may be useful in any system that includes regeneration and process airstreams through a rotor, such as VOC scrubbers. Moreover, while humidity is measured in the disclosed embodiment, the invention is not to be limited to this particular parameter. Any parameter that may vary throughout the profile of an airstream may be suitable for such measurement, as long as the appropriate sensor module is used.

Although the invention has been described with reference to specific embodiments, it will be understood by those skilled in the art that various changes may be made without departing from the spirit or scope of the invention. For instance, the numerous details set forth herein, for example, details relating to the configuration and operation of the described embodiments of the dehumidifier units, are provided to facilitate the understanding of the invention and are not provided to limit the scope of the invention. Accordingly, the disclosure of embodiments of the invention is intended to be illustrative of the scope of the invention and is not intended to be limiting.

What is claimed is:

1. A fluid processing system for treating a fluid, comprising:
a passage through which a process fluid stream is directed in a process flow direction, the process fluid stream containing fluid to be processed; and
a sensing unit disposed at least partially in the process fluid stream for sensing a parameter relevant to the processing, the sensing unit comprising:
a sensor having a sensing section for contact with the fluid from the process fluid stream to measure the parameter in the process fluid stream; and
a manifold in communication with the sensing section of the sensor, the manifold comprised of at least one trunk section and plural branch sections in fluid communication with the at least one trunk section, each of the branch sections having a branch inlet opening for receiving fluid from the process fluid stream, each of the branch inlet openings being disposed at a different location across the process fluid stream, wherein
fluid in the process fluid stream is directed into each of the branch inlet openings, through the branch sections, into the trunk section where the fluid is presented to the sensing section of the sensor, and then back into the process fluid stream.

2. The system according to claim 1, wherein the sensor is a humidity sensor and the parameter is the humidity level of the process fluid stream.

3. The system according to claim 2, wherein the humidity sensor outputs a weighted average humidity value of the process fluid.

4. The system according to claim 2, wherein the humidity level is defined by the dew point or frost point of the process fluid.

5. The system according to claim 1, wherein the trunk section includes a fluid outlet for discharging the process fluid flowing through the trunk section back into the process fluid stream.

6. The system according to claim 5, wherein the sensor section of the sensor is disposed within the trunk section adjacent the fluid outlet of the trunk section.

7. The system according to claim 5, wherein the fluid outlet of the trunk section is disposed close to a wall of the passage.

8. The system according to claim 1, wherein the plural branch inlet openings are disposed at various locations along a cross-section of the passage, the cross-section being orthogonal to a general flow direction of the process fluid stream.

9. The system according to claim 8, wherein each of the plural branch inlet openings is disposed substantially along a same plane defining the cross-section of the passage.

10. The system according to claim 1, wherein each of the plural branch inlet openings is disposed so as to face a general flow direction of the process fluid stream.

11. The system according to claim 1, wherein plural sensing units are disposed spaced apart with respect to the process flow direction in the process fluid stream.

12. The system according to claim 1, wherein the manifold is disposed in the passage, and the fluid in the process fluid stream that is directed into each of the branch inlet openings, through the branch sections, into the trunk section, and back into the process fluid stream never leaves the passage before returning to the process fluid stream.

13. A fluid processing system for treating a fluid, comprising:
a rotor having at least a process segment through which a process fluid stream is directed in a process flow direction and a regeneration segment through which a regeneration fluid stream is directed in a regeneration flow direction;
a blowing device disposed on one side of the rotor for causing movement of a target fluid stream through a passage; and
a sensing unit disposed at least partially in the target fluid stream on one side of the rotor for sensing a parameter, the sensing unit comprising:
a sensor having a sensing section for contact with the fluid from the target fluid stream to measure the parameter in the target fluid stream; and
a manifold in communication with the sensing section of the sensor, the manifold comprised of at least one trunk section and plural branch sections in fluid communication with the at least one trunk section, each of the branch sections having a branch inlet opening for receiving fluid from the target fluid stream, each of the branch inlet openings being disposed at a different location across the target fluid stream, wherein
fluid in the target fluid stream is directed into each of the branch inlet openings, through the branch sections, into the trunk section where the fluid is presented to the sensing section of the sensor, and then back into the target fluid stream.

14. The system according to claim 13, wherein target fluid stream is the process fluid stream downstream of the process segment of the rotor, the sensing unit is a humidity sensing unit disposed in the process fluid stream, and the parameter is the humidity level of the process fluid stream.

15. The system according to claim 14, wherein the humidity sensor outputs a weighted average humidity value of the process fluid.

16. The system according to claim 14, wherein the humidity level is defined by the dew point or frost point of the process fluid.

17. The system according to claim 14, wherein the trunk section includes a fluid outlet for discharging the process fluid flowing through the trunk section back into the process fluid stream.

18. The system according to claim 17, wherein the sensor section of the sensor is disposed within the trunk section adjacent the fluid outlet of the trunk section.

19. The system according to claim 17, further comprising ductwork for guiding the process fluid downstream of the rotor, wherein
the fluid outlet of the trunk section is disposed close to a wall of the ductwork.

20. The system according to claim 14, further comprising ductwork for guiding the process fluid downstream of the rotor,
wherein the plural branch inlet openings are disposed at various locations along a cross-section of the ductwork, the cross-section being orthogonal to a general flow direction of the process fluid stream.

21. The system according to claim 20, wherein each of the plural branch inlet openings is disposed substantially along a same plane defining the cross-section of the ductwork.

22. The system according to claim 14, wherein each of the plural branch inlet openings is disposed so as to face a general flow direction of the process fluid stream.

23. The system according to claim 14, wherein plural sensing units are disposed spaced apart with respect to the process flow direction in the process fluid stream.

24. The system according to claim 13, wherein the manifold is disposed in the passage, and the fluid in the target fluid stream that is directed into each of the branch inlet openings, through the branch sections, into the trunk section, and back into the process fluid stream never leaves the passage before returning to the target fluid stream.

25. A control method for controlling a fluid processing system for treating a fluid, the system comprising a passage through which a process fluid stream is directed in a process flow direction, the process fluid stream containing fluid to be processed, and a sensing unit disposed at least partially in the process fluid stream for sensing a parameter relevant to the processing, the sensing unit including a sensor having a sensing section for contact with the fluid from the process fluid stream to measure the parameter in the process fluid stream, and a manifold in communication with the sensing section of the sensor, the manifold comprised of at least one trunk section and plural branch sections in fluid communication with the at least one trunk section, each of the branch sections having a branch inlet opening for receiving fluid from the process fluid stream, each of the branch inlet openings being disposed at a different location across the process fluid stream, the method comprising:
directing fluid in the process fluid stream into each of the branch inlet openings, through the branch sections, into the trunk section where the fluid is presented to the sensing section of the sensor, and then back into the process fluid stream;
determining a weighted average of the parameter of the fluid in the process fluid stream from the fluid presented to the sensing section of the sensor; and
controlling the fluid processing system based on the determined weighted average of the parameter.

26. The control method according to claim 25, wherein the sensor is a humidity sensor and the parameter is the humidity level of the process fluid stream.

27. The control method according to claim 25 wherein the humidity level is defined by the dew point or frost point of the process fluid.
